(19) United States
(12) Patent Application Publication
(10) Pub. No.: US 2026/0023610 A1
(43) Pub. Date: Jan. 22, 2026

(54) Zero Trust Protocol for Attestation and Authorization of Applications and Shared Resources

(71) Applicant: Dell Products L.P., Round Rock, TX (US)

(72) Inventors: Sagar Alatgi, Bangalore (IN); Shrirathna K G, Udupi (IN); Shekar Babu Suryanarayana, Bangalore (IN)

(21) Appl. No.: 18/779,140

(22) Filed: Jul. 22, 2024

(51) Int. Cl. G06F 9/50; G06F 9/4401

(52) U.S. Cl. CPC G06F 9/5027; G06F 9/4401

(57) ABSTRACT

A firmware management operation. The firmware management operation includes providing an information handling system with a distributed Basic Input Output System (BIOS) and a shared resource; identifying a processor environment installed on an information handling system from a plurality of processor environments, the processor environment comprising a processor architecture, the processor architecture comprising a plurality of processor core types; and, performing a shared resource trust operation via the distributed BIOS, the shared resource trust operation using shared resource trust information to provide security measures which enable zero trust access by an application to the shared resource of the information handling system.

### BACKGROUND OF THE INVENTION

### Field of the Invention

The present invention relates to information handling systems. More specifically, embodiments of the invention relate to performing a firmware management operation.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

### SUMMARY OF THE INVENTION

In one embodiment the invention relates to a computer-implementable method for performing a firmware management operation, comprising: providing an information handling system with a distributed Basic Input Output System (BIOS) and a shared resource; identifying a processor environment installed on an information handling system from a plurality of processor environments, the processor environment comprising a processor architecture, the processor architecture comprising a plurality of processor core types; and, performing a shared resource trust operation via the distributed BIOS, the shared resource trust operation using shared resource trust information to provide security measures which enable zero trust access by an application to the shared resource of the information handling system.

In another embodiment the invention relates to a system comprising: a processor; a data bus coupled to the processor; and a non-transitory, computer-readable storage medium embodying computer program code, the non-transitory, computer-readable storage medium being coupled to the data bus, the computer program code interacting with a plurality of computer operations and comprising instructions executable by the processor and configured for: providing an information handling system with a distributed Basic Input Output System (BIOS) and a shared resource; identifying a processor environment installed on an information handling system from a plurality of processor environments, the processor environment comprising a processor architecture, the processor architecture comprising a plurality of processor core types; and, performing a shared resource trust operation via the distributed BIOS, the shared resource trust operation using shared resource trust information to provide security measures which enable zero trust access by an application to the shared resource of the information handling system.

In another embodiment the invention relates to a computer-readable storage medium embodying computer program code, the computer program code comprising computer executable instructions configured for: providing an information handling system with a distributed Basic Input Output System (BIOS) and a shared resource; identifying a processor environment installed on an information handling system from a plurality of processor environments, the processor environment comprising a processor architecture, the processor architecture comprising a plurality of processor core types; and, performing a shared resource trust operation via the distributed BIOS, the shared resource trust operation using shared resource trust information to provide security measures which enable zero trust access by an application to the shared resource of the information handling system.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a general illustration of components of an information handling system as implemented in the system and method of the present invention;

FIG. 2 shows a simplified block diagram of multi-processor operating environment;

FIG. 3 shows a simplified block diagram of an architecture-specific distributed firmware management platform;

FIGS. 4a, 4b and 4c, generally referred to as FIG. 4, are a simplified block diagram showing the performance of certain distributed firmware management operations;

FIGS. 5a, 5b and 5c, generally referred to as FIG. 5, show a simplified block diagram showing a simplified block diagram of a shared resource system;

FIGS. 6a, 6b and 6c, generally referred to as FIG. 6, show a simplified block diagram showing a shared resource system; and,

FIGS. 7a and 7b, generally referred to as FIG. 7, show a sequence diagram for a shared resource trust operation.

### DETAILED DESCRIPTION

A system, method, and computer-readable medium are disclosed for performing a firmware management operation, described in greater detail herein. Various aspects of the invention reflect an appreciation that it is not uncommon for certain firmware components of a Basic Input/Output System (BIOS) associated with an information handling system (IHS) to be added, deleted, updated, revised, replaced, or restored over time. Likewise, various aspects of the invention reflect an appreciation that such BIOS firmware components are often added, deleted, updated, revised, replaced, or restored to provide security updates, fix known software bugs, improve performance, add new features and functionalities, and so forth.

Various aspects of the present disclosure reflect an appreciation that trust operations such as zero trust type operations often require verification of substantially every user and device. Various aspects of the present disclosure include an appreciation that zero trust type operations often enforce strict access controls based on the principle of least privilege where the zero trust operation uses a philosophy that trust should not be granted by default and should be continuously verified throughout the user and device lifecycle.

Various aspects of the present disclosure include an appreciation that zero trust type operations often require a security protocol such as a Secure Production Identity Framework for Everyone (SPIFFE) security protocol as well as content in a standardized format such as a SPIFFE Verifiable Identity Document (SVID) format for representing and exchanging identity information in dynamic environments, ensuring secure and interoperable authentication. Various aspects of the present disclosure include an appreciation that SVIDs are often cryptographically verifiable documents that provide a foundation for implementing a zero trust security model, thus allowing mutually authenticated and communicated secure content in distributed systems.

Various aspects of the present disclosure include an appreciation that zero trust type operations can present security vulnerabilities when sharing resources. Various aspects of the present disclosure include an appreciation that known schemas for implementing resource access often lacks security checks beyond basic locking mechanisms which can leave shared resources vulnerable to corruption and unauthorized access, especially when multiple processes attempt simultaneous writes. For example, during an NVMe Boot Partition update, multiple processes can acquire the access to the boot partition resulting in multiple resources accessing the boot partition. Various aspects of the present disclosure include an appreciation that a vulnerable access could result in a boot to operating system fault.

Various aspects of the present disclosure include an appreciation that zero trust type operations can result in challenges implementing a zero trust zone because transitioning to a zero-trust architecture can introduce complexities in ensuring secure access to shared resources. Various aspects of the present disclosure include an appreciation that many known trust mechanisms such as certificates, hashes, and secure blobs can be reverse-engineered, thus potentially compromising the integrity of the system and allowing unauthorized access.

Various aspects of the present disclosure include an appreciation that known security measures such as locking mechanisms and access controls can be insufficient in guaranteeing the integrity of shared resources at operating system runtime (OS RT). For example, a vulnerability in video projection systems can be seen where unauthorized access to sensitive content is possible due to inadequate protection of internal resources. This unauthorized access can pose a significant security risk, especially in shared resource environments. Various aspects of the present disclosure include an appreciation that to mitigate the risk of security breaches, it would be desirable to provide dynamic security measures that adapt to changing threat landscapes and ensure continuous authentication and authorization.

A system and method are disclosed for performing a shared resource trust operation. In certain embodiments, the shared resource trust operation includes a trusted enclave operation. In certain embodiments, the trusted enclave operation provides an information handling system with a trusted enclave which enables zero trust access. In certain embodiments, the trusted enclave is created dynamically. In certain embodiments, the trusted enclave is applied to shared resources of the information handling system.

In certain embodiments, the shared resource trust operation includes a secure signature trust operation. In certain embodiments, the secure signature trust operation uses a remote storage authenticated BIOS interface (ABI) based operating system runtime application which authorizes SVID mapped secure signatures. In certain embodiments, the trusted enclave operation generates a trusted channel which allows the SVID and the authorized application to securely access the information handling system resources. In certain embodiments, the trusted channel is generated dynamically.

Such a shared resource trust operation advantageously safeguards information handling system resources during operating system runtime: The SVID-based firmware operation provides zero-trust protection, ensuring uncompromised security at every level of operation.

In certain embodiments, the shared resource trust operation include generating and using a secured firmware zero trust protocol (SFZP) which provides a zero-trust framework that seamlessly provides end to end security, ensuring the protection of the information handling system resource.

In certain embodiments, the shared resource trust operation provides an extended root of trust which includes 3-factor authentication and authorization. In certain embodiments, the shared resource trust operation uses the remote storage ABI combined with the secured firmware zero trust protocol to provide the extended root of trust.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, read-only memory (ROM), and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

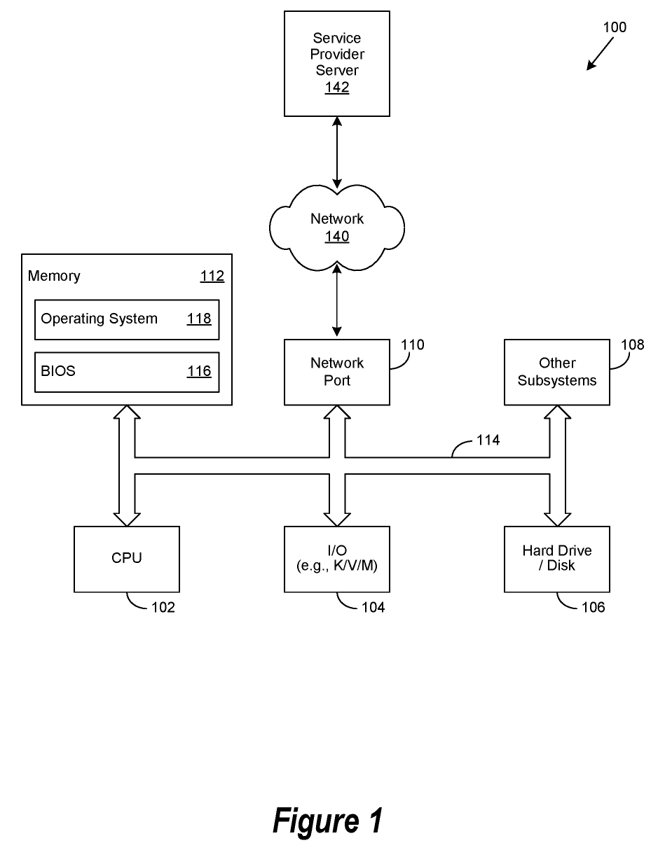

FIG. 1 is a generalized illustration of an information handling system that can be used to implement the system and method of the present invention. In certain embodiments, the information handling system (IHS) 100 may be implemented to include a processor (e.g., central processor unit or “CPU”) 102, various input/output (I/O) devices 104, such as a display, a keyboard, a mouse, a touchpad, or a touchscreen, and associated controllers, a hard drive or disk storage 106, and various other subsystems 108. In various embodiments, the IHS 100 may also be implemented to include a network port 110 operable to connect to a network 140, which in turn may be implemented to provide access to a service provider server 142. In various embodiments, the IHS 100 may likewise be implemented to include system memory 112, which is interconnected to the foregoing via one or more buses 114.

In various embodiments, system memory 112 may be configured to store program code, or data, or both, which in turn may be implemented to be accessible and executable by the CPU 102. In various embodiments, system memory 112 may be implemented using any suitable memory technology. Examples of such memory technology include random access memory (RAM), static RAM (SRAM), dynamic RAM (DRAM), synchronous dynamic RAM (SDRAM), non-volatile RAM (NVRAM), read-only memory (ROM), erasable programmable read-only memory (EPROM), electrically erasable programmable ROM (EEPROM), complementary metal-oxide-semiconductor (CMOS) memory, flash memory, or any other type of computer memory, whether it may be volatile or non-volatile. In various embodiments, system memory 112 may include one or more dual in-line memory modules (DIMMs), each containing one or more RAM modules mounted onto an integrated circuit board.

In various embodiments the system memory 112 may further be implemented to include a Basic Input/Output System (BIOS) 116, or an operating system (OS) 118, or both. Skilled practitioners of the art will be aware that BIOS 116, also known as System BIOS, ROM BIOS, or personal computer (PC) BIOS, is a type of firmware used to provide runtime services for an OS 118 to perform hardware initialization during the booting process of an IHS 100. Those of skill in the art will likewise be aware that firmware is a combination of persistent memory, program code, and data that provides low-level control of an IHS’s 100 hardware. In various embodiments, the BIOS 116 may be implemented to initialize and test certain hardware components of its associated IHS 100 during the booting process (e.g., Power-On Self-Test, or “POST”), followed by loading a boot loader from a particular mass storage device, which in turn may then be used to initialize a kernel.

In various embodiments, such BIOS 116 firmware may be implemented to provide hardware abstraction services to higher-level software such as an OS 118. In various embodiments, BIOS 116 firmware may be implemented in a less complex IHS 100 as an OS 118, performing all control, monitoring, and data manipulation functions. In various embodiments, certain components of a particular IHS 100 may be implemented to have its own firmware, which may store operational variables, data structures, or in general, any sort of information.

In various embodiments, NVRAM may be implemented to store a BIOS 116 associated with the IHS 100. In various embodiments, the NVRAM may also be implemented to hold the initial processor instructions required to bootstrap the IHS 100, store calibration constants, passwords, or setup information, or a combination thereof. In various embodiments, such setup information may be stored as variables in the NVRAM such that the variables are available during system boot from a power-off state. Various embodiments of the invention reflect an appreciation that such variables may need to be modified, revised, updated, restored, or replaced from time to time if they become corrupted. In various embodiments, an NVRAM driver may be implemented to use NVRAM headers to initialize and enable read/write services for updating or restoring such variables. Accordingly, as it relates to various embodiments of the invention, the terms “firmware,” “NVRAM,” or “BIOS” may be used generically and interchangeably.

In various embodiments, the functionality of a BIOS 116 may be implemented according to the Unified Extensible Firmware Interface (UEFI) specification, which describes how an IHS’s 100 firmware interacts with a particular OS 118. Various embodiments of the invention reflect an appreciation that UEFI, as typically implemented, may offer certain features and benefits that are not available from traditional BIOS 116 implementations, such as faster boot times, improved security, support for larger storage devices, and higher definition graphical user interfaces (GUIs). In addition, UEFI stores all data related to the IHS’s 100 initialization and startup within an .efi file, rather than on its associated firmware. In typical implementations, the .efi file may be stored on a special memory partition known as an EFI System Partition (ESP), which also contains the IHS’s 100 bootloader.

In various embodiments, BIOS 116 may be instantiated as a distributed BIOS 116. As used herein, a distributed BIOS 116 broadly refers to a BIOS 116 that includes a plurality of BIOS 116 components, or a plurality of BIOS 116 variables, or a plurality of BIOS 116 storage locations, or a combination thereof. In various embodiments, the distributed BIOS 116 may be implemented to function with any of a plurality of processor environments, described in greater detail herein.

In various embodiments, the IHS 100 may be implemented to perform a firmware management operation. As used herein, a firmware management operation broadly refers to any task, function, operation, procedure, or process performed, directly or indirectly, to store, retrieve, aggregate, disaggregate, add, delete, modify, revise, update, replace, or restore one or more individual BIOS 116 components, described in greater detail herein, or one or more individual BIOS 116 variables, likewise described in greater detail herein, or a combination thereof, in one or more memory 112 locations associated with a particular IHS 100. In certain embodiments, the firmware management operation may be performed during operation of an IHS 100. In various embodiments, performance of the firmware management operation may result in the realization of improved operation of an IHS 100.

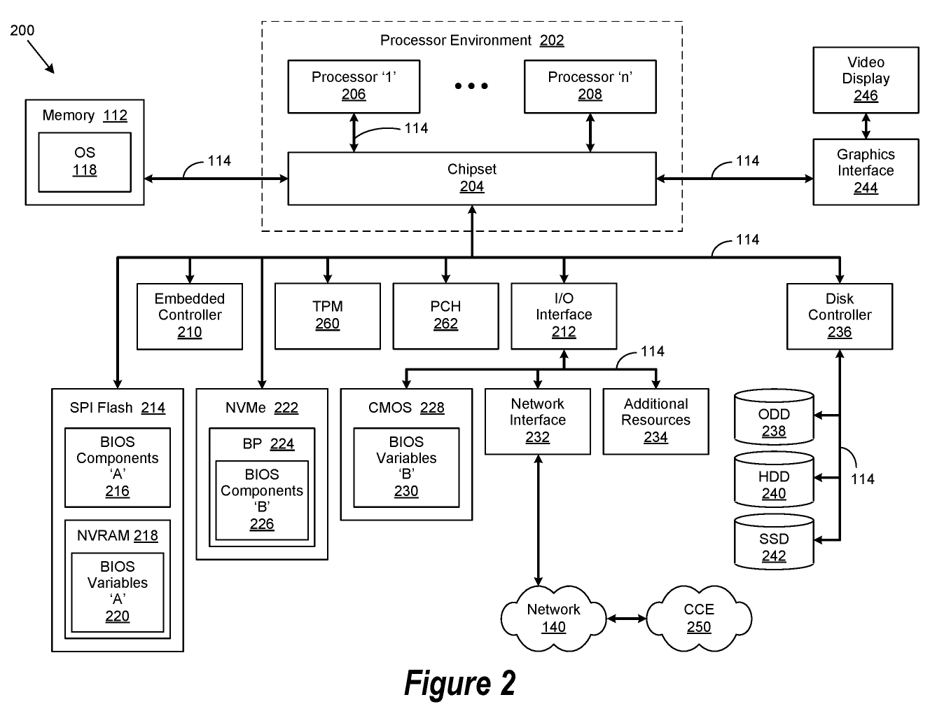

FIG. 2 shows a simplified block diagram of multi-processor operating environment implemented in accordance with an embodiment of the invention. As used herein, a multi-processor operating environment 200, such as that shown in FIG. 2, broadly refers to any instrumentality, or aggregate of instrumentalities, that may be implemented to compute, classify, process, transmit, receive, retrieve, originate, switch, store, display, manifest, detect, record, reproduce, handle, or utilize, or a combination thereof, any form of information, intelligence, or data for business, scientific, control, entertainment, or other purpose, through the use of a particular processor environment (PE) 202. For example, the multi-processor environment 200 may be implemented as a personal computer, a laptop computer, a smart phone, a tablet computer or other consumer electronic device, a network server, a network storage device, or other network communication device, and so forth. In various embodiments, a multi-processor operating environment 200 may be implemented to include processing resources for executing machine-executable code, such as a central processing unit (CPU), a programmable logic array (PLA), an embedded device such as a System-on-a-Chip (SoC), or other control logic hardware.

In various embodiments, the multi-processor operating environment 200 may be implemented to include a PE 202. In various embodiments, the PE 202 may be implemented to include a chipset 204 and one or more processors ‘1’ 206 through ‘n’ 208. In various embodiments, the processors ‘1’ 206 through ‘n’ 208 implemented within a PE 202 may have the same, or different, architectures. In various embodiments, a chipset 204 may be implemented to support one or more architectures corresponding to the processors ‘1’ 206 through ‘n’ 208. In various embodiments, the one or more architectures can include an x86 type processor architecture, an ARM type processor architecture, or a combination thereof. In various embodiments, a processor environment implementing an x86 type processor architecture provides an x86 type processor environment. In various embodiments, a processor environment implementing an ARM type processor architecture provides an ARM type processor environment.

As an example, processors ‘1’ 206 through ‘n’ 208 of a particular PE 202 may be implemented to be the same in a server. In this example, each processor may be assigned to be a resource to one or more virtual machines (VMs). As another example, processor ‘1’ 206 may be implemented as a multi-core processor in a graphics work station, while processor ‘n’ 208 may be implemented a Graphics Processing Unit (GPU), familiar to skilled practitioners of the art.

In various embodiments, each of the processors ‘1’ 206 through ‘n’ 208 of a particular PE 202 may be implemented to run the same OS 118. Likewise, individual processors ‘1’ 206 through ‘n’ 208 of a particular PE 202 may be implemented in various embodiments to run a different same OS 118. For example, processor ‘1’ 206 may be implemented to run Microsoft® Windows®, while processor ‘n’ 208 may be implemented to run a version of Linux®.

In various embodiments, one or more PEs 202 selected from a plurality of PEs 202 may be implemented within the multi-processor operating environment 200. In certain of these embodiments, a particular PE 202 selected from a plurality of PEs 202 may be vendor-specific. In various embodiments, a particular PE 202 selected from a plurality of PEs 202 may be implemented as a System on a Chip (SoC), familiar to those of skill in the art. In various embodiments, the PE 202 may be implemented to include a plurality of vendor-specific SoCs provided by different vendors, or different versions of an SoC provided by the same vendor.

In various embodiments, the multi-processor operating environment 200 may likewise be implemented to include system memory 112. In various embodiments, the system memory 112 may in turn be implemented to include an operating system (OS) 118. In various embodiments, the multi-processor operating environment 200 may be implemented to include an embedded controller (EC) 210, a Trusted Platform Module (TPM) 260, a Platform Controller Hub (PCH) 262, an input/output (I/O) interface 212, a disk controller 236, and a graphics interface 244, or a combination thereof.

In various embodiments, the multi-processor operating environment 200 may likewise be implemented to include Nonvolatile Random Access Memory (NVRAM) 218, Serial Peripheral Interface (SPI) Flash memory 214, Nonvolatile Memory Express (NVMe) 222 memory, and a complementary metal-oxide-semiconductor (CMOS) 228 chip, or a combination thereof. Skilled practitioners of the art will be familiar with NVRAM 218, which in general usage broadly refers to Random Access Memory (RAM) that retains data if power is lost. In various embodiments, NVRAM 218 may be implemented to hold initial processor instructions used to bootstrap an information handling system (IHS), described in greater detail herein. In various embodiments, NVRAM 218 may be implemented in the form of flash memory, such as SPI Flash 214 memory, Erasable Programmable Read-Only Memory (EPROM), Electrically Erasable Programmable Read-Only Memory (EEPROM), or Ferroelectric RAM (F-RAM), Magnetoresistive RAM (MRAM), Phase-Change RAM (PRAM), or a combination thereof.

Those of skill in the art will likewise be familiar with SPI Flash 214 memory, which is a type of EEPROM memory implemented in accordance with the SPI standard, where the data stored within it is architecturally arranged in blocks. Various embodiments of the invention reflect an appreciation that while data stored within SPI Flash memory 214 is erased at the block level, it may be read or written at the byte level. Likewise, various embodiments of the invention reflect an appreciation that the ability to erase blocks of data within SPI Flash 214 memory may be advantageous in certain embodiments as erase speeds can be improved, and as a result, allow information to be stored more efficiently and compactly.

Likewise, skilled practitioners of the art will be familiar with NVMe, which is an open, logical device interface specification for accessing non-volatile storage media implemented within an IHS. Certain embodiments of the invention reflect an appreciation that NVMe 222 memory is currently available in various form factors, such as solid state drives (SSDs), Peripheral Component Interconnect Express (PCIe) memory cards, and M.2 memory cards. Various embodiments of the invention likewise reflect an appreciation that NVMe, as a logical device interface, is able to support low latency and internal parallelism for solid state storage devices, which can reduce Input/Output (I/O) overhead while providing other known performance improvements.

In various embodiments, the SPI Flash 214 memory may be implemented to receive, store, manage, and provide access to one or more Basic Input/Output System (BIOS) components ‘A’ 216. As used herein, a BIOS component broadly refers to one or more discrete portions of firmware program code that may be used, directly or indirectly, by a BIOS during its operation. In various embodiments, the SPI Flash 214 memory may be implemented to include certain NVRAM 218 memory. In various embodiments, the NVRAM 218 memory may in turn be implemented to receive, store, manage, and provide access to one or more BIOS variables ‘A’ 220, such as configuration settings, for use by the BIOS of an associated IHS.

In various embodiments, the NVMe 222 memory may be implemented to include a boot partition (BP) 224. Those of skill in the art will be familiar with the concept of a BP 224, which in common usage broadly refers to a primary memory partition that contains a boot loader, which is a portion of program code responsible for booting the OS 118 of an associated IHS. In various embodiments, the BP 224 may in turn be implemented to receive, store, manage, and provide access to one or more BIOS components ‘B’ 226. In various embodiments, the NVMe 222 memory may be implemented without a BP 224. Nonetheless, the NVMe 222 memory may be implemented in certain of these embodiments to still receive, store, manage, and provide access to one or more BIOS components ‘B’ 226.

In various embodiments, the I/O interface 212 may be implemented to interact with a complementary metal-oxide semiconductor (CMOS) 228 chip. In various embodiments, the CMOS 228 chip may be implemented to include a real-time clock and RAM memory that is backed-up by a battery. In various embodiments, the memory in the CMOS 228 chip may be implemented to receive, store, manage, and provide access to one or more BIOS variables ‘B’ 230.

In various embodiments, the I/O interface 212 may likewise be implemented to interact with a network interface 232, or additional resources 234. or both. In various embodiments, the network interface 232 may be implemented to provide access and connectivity to a network 140. In turn, the network 140 may be implemented in various embodiments to provide access and connectivity to a cloud computing environment (CCE) 250. Skilled practitioners of the art will be familiar with cloud computing, which is defined by the National Institute of Standards and Technology (NIST) as a model for enabling ubiquitous, convenient, on-demand network access to a shared pool of configurable computing resources (e.g., networks, servers, storage, applications, portions of program code, firmware components, data, services, and so forth) that can be rapidly provisioned and released with minimal management effort or service provider interaction.

In various embodiments, additional resources 234 may include a data storage system, additional graphics interfaces, a network interface card (NIC), a sound or video processing card, and so forth. In various embodiments, additional resources 234 may be implemented on a main circuit board of an IHS, or a separate circuit board or add-in card thereof, or a device that is external to the IHS, or a combination thereof. In various embodiments, the disk controller 236 may be implemented to interact with, and manage access to and from, an optical disk drive (ODD) 238, a hard disk drive (HDD) 240, or a solid state drive (SSD) 242, or a combination thereof.

In various embodiments, the graphics interface 242 may be implemented to present visual content on an associated video display. In certain of these embodiments, the graphics interface 242 may likewise be implemented to receive user gesture input from the video display 244, such as through the use of a touch-sensitive screen. In various embodiments, the system memory 112, the chipset 204, one or more processors ‘1’ 206 through ‘n’ 208, the EC 210, the TPM 260, the PCH 262, the SPI Flash 214 memory, the NVMe 222 memory, the I/O interface 212, the CMOS 228 chip, the network interface 232, the additional resources 234, the disk controller 236, the ODD 238, the HDD 240, the SSD 242, the graphics interface 244, and the video display 246 may be implemented to provide and receive data to and from one another via one or more buses 114.

In various embodiments, a firmware management operation may be implemented to include a distributed firmware management operation. As used herein, a distributed firmware management operation broadly refers to a firmware management operation, described in greater detail herein, performed directly, or indirectly, within a multi-processor operating environment 200 to store, retrieve, aggregate, disaggregate, add, delete, modify, revise, update, replace, or restore one or more BIOS components ‘A’ 216 or ‘B’ 226, or one or more BIOS variables ‘A’ 220 or ‘B’ 230, or a combination thereof. In various embodiments, one or more BIOS components ‘A’ 216 or ‘B’ 226, or one or more BIOS variables ‘A’ 220 or ‘B’ 230, or a combination thereof, may be used, individually or in combination with one another, in the performance of a distributed firmware management operation. In various embodiments, performance of the distributed firmware management operation effectively decouples (i.e., minimizes the interrelationship between) one or more BIOS components ‘A’ 216 or ‘B’ 226, or one or more BIOS variables ‘A’ 220 or ‘B’ 230, or a combination thereof, from each other. In various embodiments, the performance of the distributed firmware management operation effectively decouples PE BIOS components from other platform BIOS components, as described herein.

In various embodiments, individual BIOS components ‘A’ 216 or ‘B’ 226 used in the performance of one or more distributed firmware management operations may be located within, or outside of, the multi-processor operating environment 200. As an example, a particular BIOS component ‘A’ 216 or ‘B’ 226 may initially be stored within a cloud computing environment (CCE) 250, described in greater detail herein. In this example, the firmware component may be retrieved from the CCE 250 by the multi-processor operating environment 200 and then respectively stored as firmware components ‘A’ 216 in NVRAM 218, or ‘B’ 226 in NVMe 222 memory, or a combination of the two.

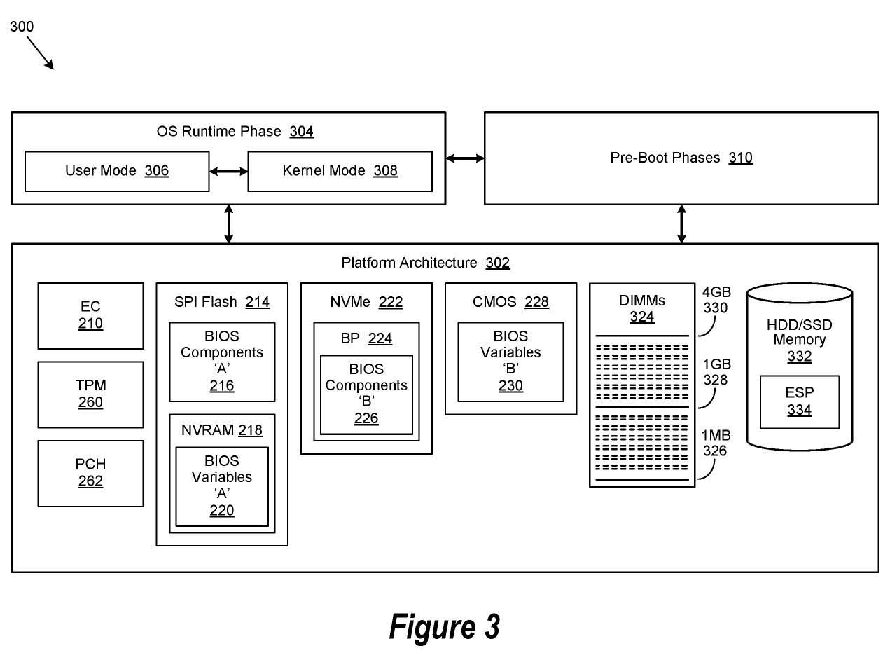

FIG. 3 shows a simplified block diagram of an architecture-specific distributed firmware management platform implemented in accordance with an embodiment of the invention. In various embodiments, the architecture-specific distributed firmware management platform (ASDFMP) 300, and its associated operation, may be implemented to accommodate architecture-specific aspects of a particular information handling system (IHS), described in greater detail herein. As an example, various IHS’s may utilize different processors (e.g., Intel^{®}, AMD^{®}, Qualcom^{®}, Broadcom^{®}, NVidia^{®}, and so forth), and as a result, may require the use of a Basic Input/Output System (BIOS) specific to their respective architecture, or associated operating system (OS), or both, at boot time. In various embodiments, the ASDFMP 300 may be implemented to perform one or more firmware management operations, described in greater detail herein.

In various embodiments, the ASDFMP 300 may be implemented to include a platform architecture 302. In certain of these embodiments, the platform architecture 302 may be implemented to include an embedded controller (EC) 210, a Trusted Platform Module (TPM) 260, a Platform Controller Hub (PCH) 262, Serial Peripheral Interface (SPI) Flash 214 memory, Nonvolatile Memory Express (NVMe) 222 memory, and a complementary metal-oxide-semiconductor (CMOS) 228 chip, or a combination thereof, as described in greater detail herein. In various embodiments, the platform architecture 302 may likewise be implemented to include one or more dual in-line memory modules (DIMMs) 324, and certain hard disk drive (HDD) memory, or solid state drive (SSD) memory, or a combination of the two 332.

In various embodiments, the EC 210 may be implemented, directly or indirectly, within the ASDFMP 300 to provide a root of trust function. As used herein, a root of trust broadly refers to a highly reliable component, such as an EC 210, that performs specific, important security functions. In various embodiments, a root of trust component may be implemented as a building block upon which other components of the ASDFMP 300 can derive security functions.

In various embodiments, the EC 210 may be implemented to perform a root of trust operation. As used herein, a root of trust operation broadly refers to a distributed firmware management operation, described in greater detail herein, performed directly, or indirectly, within an ASFDMP 300 to provide a root of trust by leveraging a secure interface to ensure integrity and security of communication between certain components of the ASDFMP 300. In various embodiments, one or more root of trust operations may be performed to enhance the security and trustworthiness of the ASDFMP 300.

Skilled practitioners of the art will be familiar with a TPM 260, which is an international standard for a secure crypto processor, typically implemented as a dedicated microcontroller designed to secure various hardware components of an ASDFMP 300 through the use of integrated cryptographic keys. In various embodiments, a TPM 260 may be implemented to increase the security of an ASDFMP 300 and to protect it against certain firmware attacks. In various embodiments, a TPM 260 may be implemented in combination with an EC 210 to perform a root of trust operation.

Those of skill in the art will likewise be familiar with a PCH 262, which broadly refers to a family of chipsets manufactured by Intel^{®} to control certain data paths and support functions used in conjunction with Intel^{®} processors. However, as used herein, a PCH 262 may broadly refer to one or more processor-agnostic functionalities of an ASDFMP 300 that may be used, directly or indirectly within it, to control various data paths and support functions associated with a particular processor. Examples of such processors include those manufactured by Intel^{®}, AMD^{®}, Qualcomm^{®}, Broadcom^{®}, NVidia^{®}, and so forth. Accordingly, various embodiments of the invention reflect an appreciation that provision of such PCH 262 functionalities may require a different implementation for each processor architecture.

In various embodiments, the SPI Flash 214 memory may be implemented to receive, store, manage, and provide access to one or more BIOS components ‘A’ 216, as described in greater detail herein. In various embodiments, the SPI Flash 214 memory may likewise be implemented to include certain NVRAM 218 memory. In various embodiments, the NVRAM 218 memory may in turn be implemented to receive, store, manage, and provide access to one or more BIOS variables ‘A’ 220, as described in greater detail herein.

In various embodiments, the NVMe 222 memory may be implemented to include a boot partition (BP) 224, described in greater detail herein. In various embodiments, the BP 224 may in turn be implemented to receive, store, and provide access to, one or more BIOS components ‘B’ 226. In various embodiments, the NVMe 222 memory may be implemented without a BP 224. Nonetheless, the NVMe 222 memory may be implemented in certain of these embodiments to still receive, store, manage, and provide access to one or more BIOS components ‘B’ 226. In various embodiments, as likewise described in greater detail herein, the CMOS 228 chip may be implemented to receive, store, and provide access to, one or more BIOS variables ‘B’ 230.

In various embodiments, the one or more DIMMs 324 may be implemented to include one or more RAM modules mounted onto an integrated circuit board. In various embodiments, the one or more DIMMs 324 may be partitioned into a low region of memory, such as from 1 megabyte (MB) 326 to 1 gigabyte (GB) 328, and a high region of memory, such as from 1GB 328 to 4GB 330. In these embodiments, the amount of memory allocated to the low and high memory regions, the memory addresses within the one or more DIMMs 324 where such allocation may occur, and how such allocation may be performed, is a matter of design choice.

In various embodiments, the HDD/SDD memory 332 may be implemented to include an extensible firmware interface (EFI) system partition (ESP) 334. Skilled practitioners of the art will be familiar with an ESP 334, which is usually implemented as a partition on a mass storage device, such as HDD/SSD memory 332, which in turn is used by an associated IHS implemented with a Unified Extensible Firmware Interface (UEFI), described in greater detail herein. In such implementations, the UEFI loads files stored within the ESP 334 to begin installing Operating System (OS) and associated utility files. In various embodiments, the ESP 334 may be implemented to contain the boot loaders, or kernel images, for all installed OS’s that may be contained in other memory partitions, device driver files for hardware devices present in its associated IHS and used by the firmware at boot time, system utility programs that are intended to be run before a particular OS is booted, and data files such as error logs.

In various embodiments, the ASDFMP 300 may be implemented to include an OS runtime phase 304, and various pre-boot phases 310, all of which are described in greater detail herein. In various embodiments, the OS runtime phase 304 may be implemented to include a user mode 306 and a kernel mode 308, both of which are likewise described in greater detail herein. In various embodiments, certain components, processes, or operations, or a combination thereof, respectively associated with the OS runtime phase 304 and the pre-boot phases 310, may be implemented to interact with various components of the platform architecture 302, as likewise described in greater detail herein.

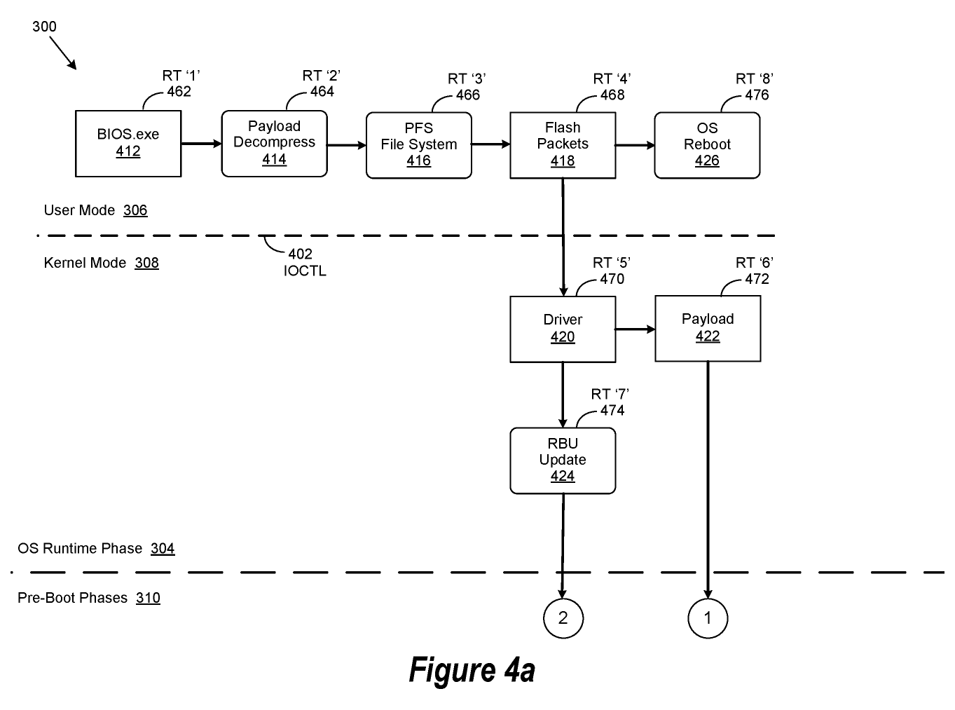

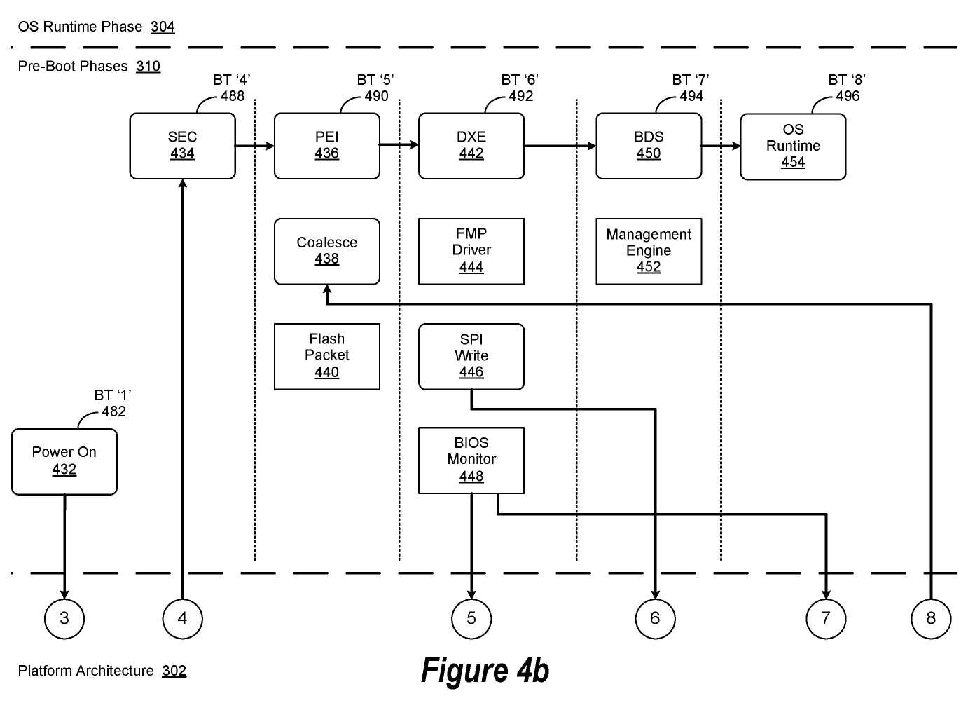

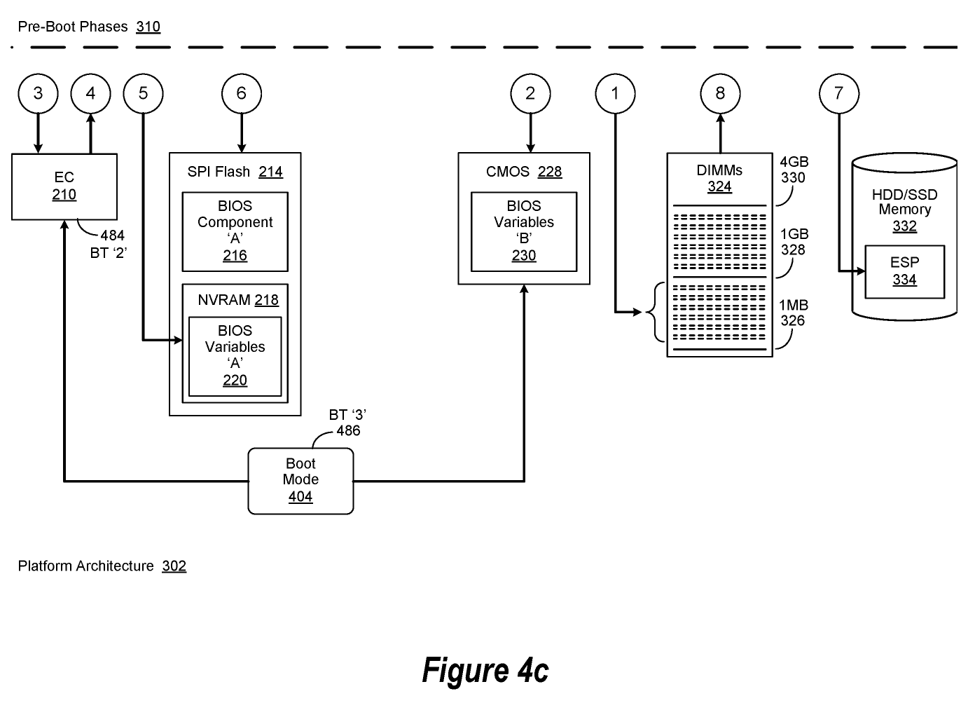

FIGS. 4a through 4c are a simplified block diagram showing an architecture-specific distributed firmware management platform (ASDFMP) implemented in accordance with an embodiment of the invention to perform certain distributed firmware management operations. In certain embodiments, the ASDFMP 300 may be implemented to include an Operating System (OS) runtime phase 304, various pre-boot phases 310, and a platform architecture 302. In various embodiments, as described in greater detail herein, the platform architecture 302 may be implemented to include an embedded controller (EC) 210, Serial Peripheral Interface (SPI) Flash 214 memory, and a complementary metal-oxide-semiconductor (CMOS) 228 chip, or a combination thereof. In various embodiments, the platform architecture 302 may likewise be implemented to include one or more dual in-line memory modules (DIMMs) 324, and certain hard disk drive (HDD) memory, or solid state drive (SSD) memory, or a combination of the two 332.

In various embodiments, the SPI Flash 214 memory may be implemented to receive, store, manage, and provide access to one or more Basic Input/Output System (BIOS) components ‘A’ 216, described in greater detail herein. In various embodiments, the SPI Flash 214 memory may likewise be implemented to include certain NVRAM 218 memory, likewise described in greater detail herein. In various embodiments, the NVRAM 218 memory may in turn be implemented to receive, store, manage, and provide access to one or more BIOS variables ‘A’ 220, as described in greater detail herein.

In various embodiments, the OS runtime phase 304 may be implemented to include a user mode 306 and a kernel mode 308. Skilled practitioners of the art will be aware that user mode 306 generally refers to a restricted mode that limits software access to system resources, while kernel mode 308 generally refers to a privileged mode that allows software to access system resources and perform privileged operations. In various embodiments, an Input/Output Control (IOCTL) 402 operation, familiar to those of skill in the art, may be performed to switch between user mode 306 and kernel mode 308. Those of skill in the art will likewise be aware that such mode switching generally involves saving the current context of an associated information handling system’s (IHS’s) processor in memory, switching to the new mode, and loading the new context into the processor.

Referring now to FIG. 4a, a distributed firmware management operation may be initiated by the ASDFMP 300 receiving a BIOS.exe 412 file in runtime (RT) step ‘1’ 462. In various embodiments, the BIOS.exe 412 file may be implemented as the combination of a flash memory utility and a payload of firmware components, described in greater detail herein. Then, in RT step ‘2’ 464 the BIOS.exe 412 is executed to decompress 414 its payload, which is then converted in RT step ‘3’ 466 into a payload file system (PFS) 416.

Flash memory packets 418 are then extracted from the PFS 416 if RT step ‘4’ 468 and provided to a memory driver 420 in RT step ‘5’ 470 to create a memory payload 422. The resulting memory payload 422 is then loaded into a lower memory region of one or more DIMMs 324, such as between 1 megabyte (MB) 326 and 1 gigabyte (GB) 328. Thereafter, a Remote BIOS Update (RBU) 424 operation may be performed in RT step ‘7’ to update certain BIOS variables ‘B’ 230 stored in the CMOS 328 chip. An OS reboot 426 operation is then performed in RT step ‘8’ 476.

Once the OS reboot 426 operation has been performed in RT step ‘8’ 476, power is applied 432 to the ASDFMP 300 in pre-boot time (BT) step ‘1’ 432. An embedded controller (EC) 210 is then invoked in BT step ‘2’ 464 which results in the activation of a boot mode 404 in BT step ‘3’ 486. In various embodiments, the boot mode 404 may be activated in BT step ‘3’ 486 by retrieving, and using, certain BIOS variables ‘B’ stored in the CMOS 228 chip.

One or more security (SEC) 434 phase operations may then be performed in BT step ‘4’ 488, followed by the performance of one or more Pre Extensible Firmware Interface (EFI) Initialization (PEI) 436 phase operations in BT step ‘5’ 490. In various embodiments, the one or more SEC 434 phase operations may be implemented to secure the boot process by preventing the loading of Unified Extensible Firmware Interface (UEFI) drivers, or boot loaders, that are not signed with an acceptable digital signature. In various embodiments, a trusted platform module (TPM), familiar to skilled practitioners of the art, may be used in the performance of one or more SEC 434 phase operations.

Those of skill in the art will likewise be aware that PEI 436 phase operations are generally performed to initialize permanent memory within a particular IHS to load and invoke initial configuration routines specific to its associated processor environment (PE), described in greater detail herein. In various embodiments, performance of the PEI 436 phase operation in BT step ‘5’ 490 may include one of more packet coalescing 438 operations being performed to coalesce individual flash memory packets previously stored in a low memory region of one or more DIMMs in RT step ‘6’ 472. In various embodiments, the individual flash memory packets may then be stored as one or more coalesced flash memory packets 440.

In various embodiments, a firmware management protocol (FMP) may be used in the performance of a Driver eXecution Environment (DXE) 442 phase operation in BT step 6’ 492 to perform an SPI write 446 operation to write the coalesced flash memory packets 440 to SPI Flash 214 memory. Skilled practitioners of the art will be familiar with a DXE 442, which as typically implemented includes a DXE Core, a DXE Dispatcher, and one or more Firmware Management Protocol (FMP) drivers 444. In general, the DXE Core component is responsible for producing a set of boot services, DXE services, and RT Services. Likewise, the DXE Dispatcher component is responsible for discovering and executing FMP drivers 444 in the correct order. In turn, the FMP drivers 444 are responsible for initializing the IHS’s processor environment (PE), described in greater detail herein. In various embodiments, the SPI write 446 operation may be performed to write certain flash memory packets associated with certain BIOS components ‘A’ 216, or certain BIOS variables ‘A’ 220, or a combination of the two. In various embodiments, the flash memory packets may contain new, updated, modified, revised, or replacement BIOS components ‘A’ 216, or BIOS variables ‘A’ 220, or a combination of the two.

In various embodiments, a BIOS monitor 448, such as BIOS IQ, produced by Dell^{®} Incorporated, of Round Rock, Texas, may be implemented within the DXE 442 phase to monitor the current values of certain BIOS variables ‘A’ 220 stored in NVRAM 218, which in certain embodiments, may be implemented within SPI Flash 214 memory. In various embodiments, the BIOS monitor 448 may likewise be implemented to monitor the status of certain data stored in the ESP 334, described in greater detail herein. Once DXE 442 phase operations are completed in BT step ‘6’ 494, the OS is then booted. In various embodiments, a boot device selection (BDS) 450 phase operation is then performed in BT step ‘7’ 494 to select a boot device. In various embodiments, a management engine (ME) 452, such as the ME 452 produced by Intel^{®} Corporation of Santa Clara, California, may be implemented to use the selected boot device in BT step ‘8’ 496 to boot the ASDFMP 300 into an OS runtime 454 state.

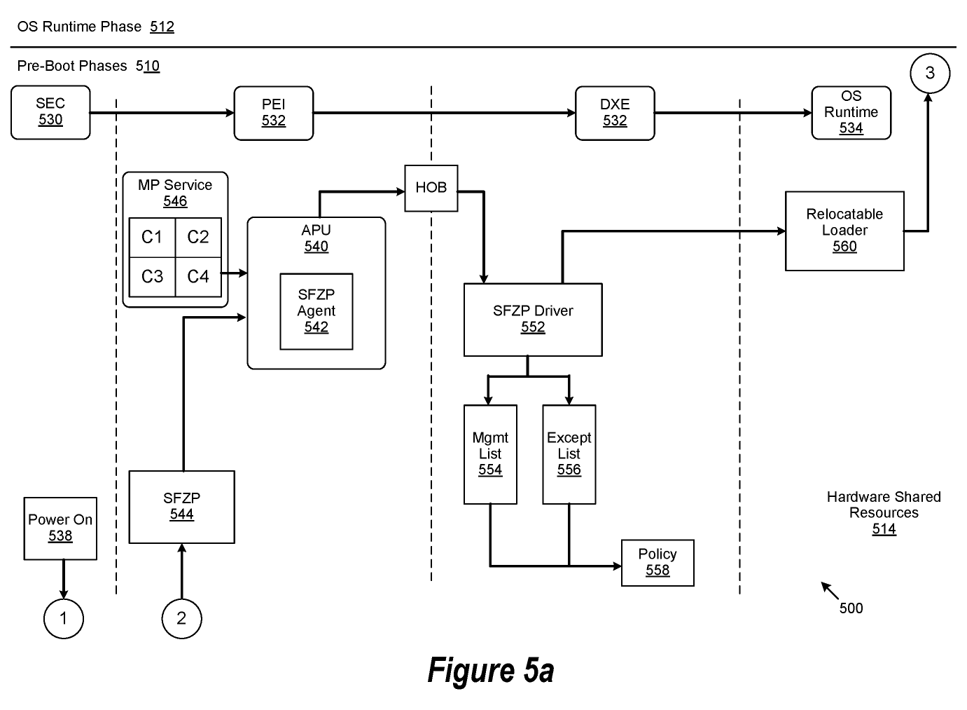

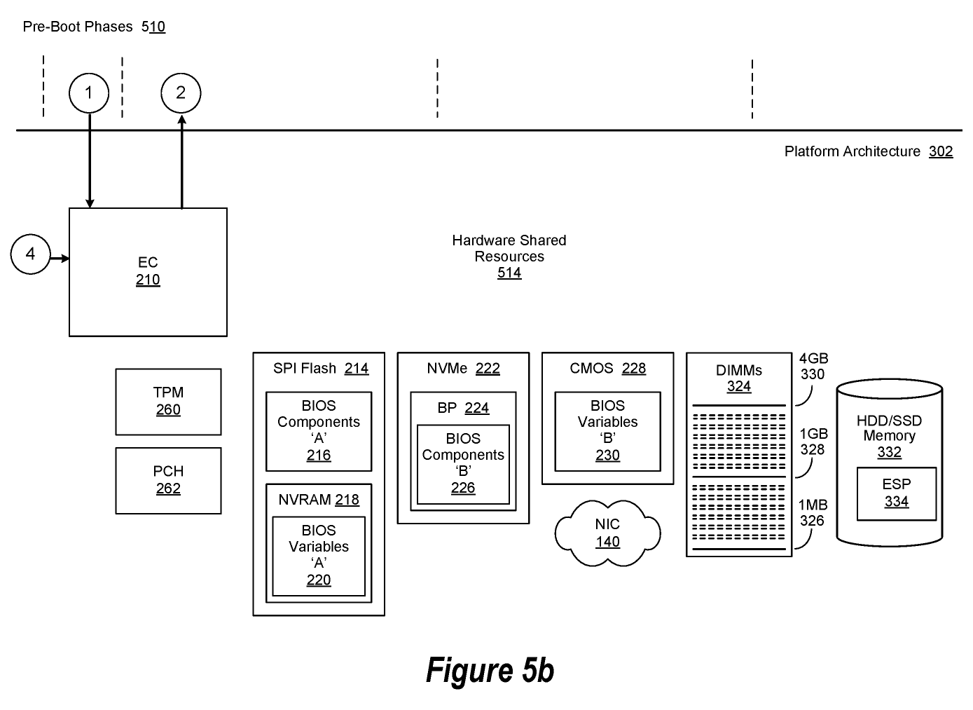

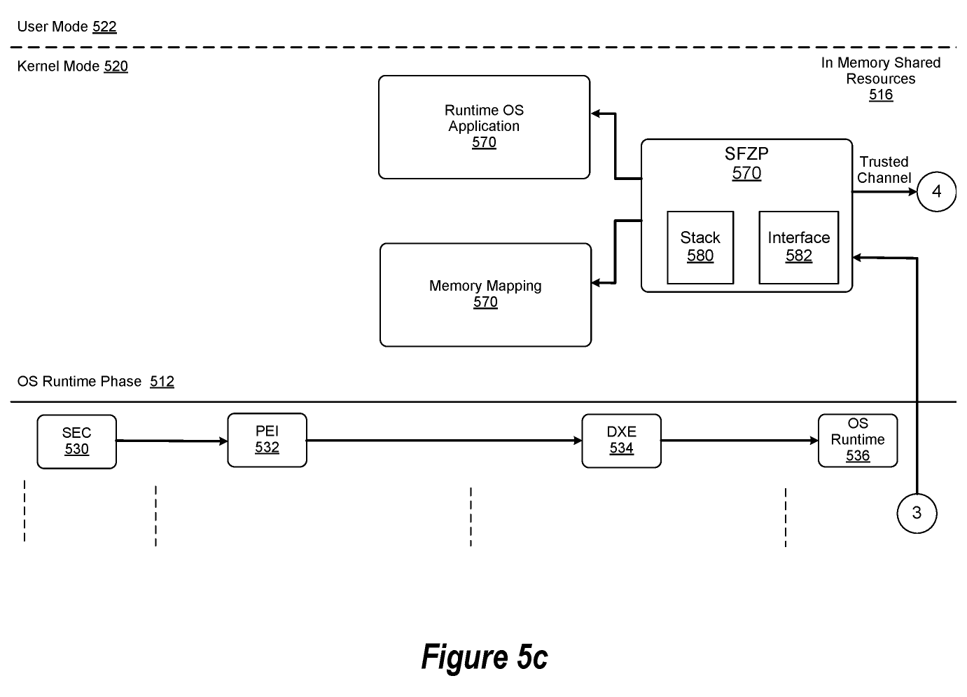

FIGS. 5a, 5b and 5c, generally referred to as FIG. 5, show a simplified block diagram showing a simplified block diagram of a shared resource system 500. In certain embodiments, the shared resource system 500 is included within an information handling system such as information handling system 100. In certain embodiments, the shared resource system 500 is included within a multi-processor operating environment such as multi-processor operating environment 200. In certain embodiments, the shared resource system includes a platform architecture 302.

In certain embodiments, a shared resource trust operation is performed by the shared resource system 500. As used herein, a shared resource trust operation broadly refers a firmware management operation, described in greater detail herein, performed, directly or indirectly, to use shared resource trust information to provide security measures which enable zero trust access by an application to a shared resource. In certain embodiments, the shared resource trust operation includes a trusted enclave operation. As used herein, a trusted enclave operation broadly refers to a firmware management operation, described in greater detail herein, performed, directly or indirectly, within a multi-processor operating environment 200 to store, retrieve, aggregate, disaggregate, add, delete, modify, revise, update, replace, or restore shared resource trust information to provide an information handling system with a trusted enclave.

In certain embodiments, the trusted enclave operation provides an information handling system with a trusted enclave which enables zero trust access. In certain embodiments, the trusted enclave is created dynamically. In certain embodiments, the trusted enclave is applied to shared resources of the information handling system. As used herein, a trusted enclave broadly refers to a trusted computing environment (such as a trusted execution environment) that provides isolation for code and data, such as code and data associated with an application or workload, from an operating system.

In certain embodiments, the shared resource trust operation includes generating and using a secured firmware zero trust protocol (SFZP) which provides a zero-trust framework that seamlessly provides end to end security, ensuring the protection of the information handling system resource. As used herein, a secured firmware zero trust protocol broadly a protocol for communicating with an application, any of a plurality of processor components (such as the components described with respect to the multi-processor operating environment in FIG. 2), or a combination thereof, regarding shared trust information.

In certain embodiments, the shared resource trust operation provides an extended root of trust which includes 3-factor authentication and authorization. In certain embodiments, the shared resource trust operation uses the remote storage ABI combined with the secured firmware zero trust protocol to provide the extended root of trust.

In certain embodiments, the shared resource system 500 includes a pre-boot portion 510, a run time portion 512, or a combination thereof. In certain embodiments, components of the pre-boot portion 510, components of the platform architecture 302, or a combination thereof, include hardware shared resources 514. In certain embodiments, components of the run-time portion 512 include in-memory shared resources.

In certain embodiments, the run-time portion 512 includes a kernel mode portion 520, a user mode portion 522, or a combination thereof. In certain embodiments, the pre-boot portion includes an SEC phase 530, a PEI phase 532, a DXE phase 534, and a run-time phase 536.

In certain embodiments, the SEC phase 530 includes a power on module 538. In certain embodiments, the PEI phase 532 includes an accelerated processing unit 540, a SFZP module 544, a microprocessor service 546, or a combination thereof. In certain embodiments, the accelerated processing unit 540 includes a SFZP agent 542. In certain embodiments, the PEI phase 532 communicates with the DXE phase 534 via a hand off block module 550. In certain embodiments, the DXE phase 544 includes a preboot SFZP driver 552, a manageability list module 554, an exception list module 556, a policy module 558, or a combination thereof. In certain embodiments, the operating system runtime phase 536 includes the relocatable loader module 560.

In certain embodiments, the kernel mode portion 520 includes a runtime secured firmware zero trust protocol (SFZP) driver 570, a memory mapping module 572, one or more operating system runtime application 574, or a combination thereof. In certain embodiments, the runtime SFZP driver 570 includes a stack module 580, an interface component 582, or a combination thereof. In certain embodiments, the preboot SFZP driver 552 and the runtime SFZP driver 570 are included within an SFZP system driver.

In certain embodiments, the trusted enclave operation integrates the dedicated accelerated processing unit (APU) 540 executing the SFZP agent 542. In certain embodiments, the SFZP agent 542 includes a Secure Production Identity Framework for Everyone (SPIFFE) agent. In certain embodiments, the SPIFFE agent is responsible for communication with shared hardware resources and validating certificates. In certain embodiments, the SPIFFE agent works with the secured firmware zero trust protocol module 544 to establish a zero-trust environment. In certain embodiments, when executing during the PEI phase, the trusted enclave operation uses the microprocessor (MP) service 546 to assign unique identifier (C1 – Cn) to the APU. In certain embodiments, when executing during the PEI phase, the trusted enclave operation initializes the SFZP agent 542. In certain embodiments, when executing during the PEI phase, the trusted enclave operation uses the embedded controller 210, which is serving as the Root of Trust (RoT), to extend the RoT to the SFZP agent 542. In certain embodiments, the embedded controller 210 communicates with the APU 540 via the SFZP module 544.

So extending the root of trust to the SFZP agent 542 enables a dynamic trust establishment to provide a trusted execution environment (TEE). As used herein, a trusted execution environment broadly refers to an environment for executing code in which the information handling system executing the code has a high level of trust in the surrounding environment because the environment can ignore threats from the rest of the information handling system. In certain embodiments, the trusted enclave operation uses the TEE to perform a measured boot of any applications 574 requesting shared resources (such as hardware shared resources 514, in memory shared resources 516, or a combination thereof). In certain embodiments, the measured boot generates security information which is used during the measured boot of the applications. In certain embodiments, the security information includes hashes such as dynamic root of trust measurement (DRTM) type hashes. In certain embodiments, the information generated during the PEI phase 532 is stored in the hand off block (HOB) 550 to pass the information to the DXE phase 534.

In certain embodiments, the trusted SFZP agent 542 communicates with the SFZP driver 552. In certain embodiments, the SFZP driver 552 manages hardware resources by verifying SPIFFE Verifiable Identity Document (SVID) documents and granting access to trusted applications 572. In certain embodiments, the relocatable loader 560 enables a remote storage based ABI based operating system runtime application 572 authorization via SPIFFE Verifiable Identity Document (SVID) mapped secure signatures. In certain embodiments, the SFZP driver 552 maintains hardware resource manageability and exception lists, respectively contained within the manageability module 554 and the exception module 556. In certain embodiments, the SFZP driver 552 details information on available and trusted hardware resources for specific operating system applications. In certain embodiments, the SFZP driver maintains an operating system policy table which determines resource usage based on a currently available manageability list. In certain embodiments, the operating system policy table is maintained within the policy module 558.

In certain embodiments, the shared resource trust operation includes a secure signature trust operation. As used herein, a secure signature trust operation broadly refers to a firmware management operation, described in greater detail herein, performed, directly or indirectly, within a multi-processor operating environment 200 to store, retrieve, aggregate, disaggregate, add, delete, modify, revise, update, replace, or restore shared resource trust information to provide shared trust identification information associated with an application, a shared resource, or a combination thereof.

In certain embodiments, the secure signature trust operation uses a remote storage authenticated BIOS interface (ABI) based operating system runtime application which authorizes SVID mapped secure signatures. In certain embodiments, the SVID is an example of shared trust identification information. In certain embodiments, the secure signature trust operation generates a trusted channel which allows the SVID and the authorized application to securely access the information handling system resources. In certain embodiments, the trusted channel is generated dynamically. In certain embodiments, the trusted channel is maintained between the runtime SFZP driver 570 and the embedded controller 210. As used herein, an authenticated BIOS interface (ABI) broadly refers to an interface between applications and shared resources that has been configured to be trusted. In certain embodiments, an ABI defines a standard interface between an application and a shared resource. In certain embodiments, ABI is maintained within the interface component 582.

In certain embodiments, the secure signature trust operation provides zero-trust protection in the operating system runtime. In certain embodiments, the runtime SFZP driver 570 is mapped to memory via the memory mapping module 572 and reallocated to operating system memory to provide services to the operating system runtime environment 512. In certain embodiments, the runtime SFZP driver 572 maintains hardware resource manageability and exception lists. In certain embodiments, the runtime SFZP driver 572 details information on available and trusted hardware resources for specific operating system applications. In certain embodiments, the SFZP driver 572 maintains an operating system policy table which determines resource usage based on a currently available manageability list.

In certain embodiments, the SFZP driver manages an SFZP stack which is reallocated and loaded into kernel space. In certain embodiments, the SFZP stack facilitates identity management across operating system runtime application and provides zero-trust protection for all in-memory shared resources. In certain embodiments, the mapped SFZP driver extends trust under the supervision of the embedded controller root of trust. In certain embodiments at runtime, applications, along with any shared resources, undergo a verification process through the ABI interface. In certain embodiments, the secure signature trust operation provides secure authorization not only during the pre-boot phase but also throughout the operating system runtime, thus securing both the hardware resources and the applications seeking access.

Such a shared resource trust operation advantageously safeguards information handling system resources during operating system runtime: In certain embodiments, the shared resource trust operation functions as a SVID-based firmware operation which provides zero-trust protection, ensuring uncompromised security at every level of operation..

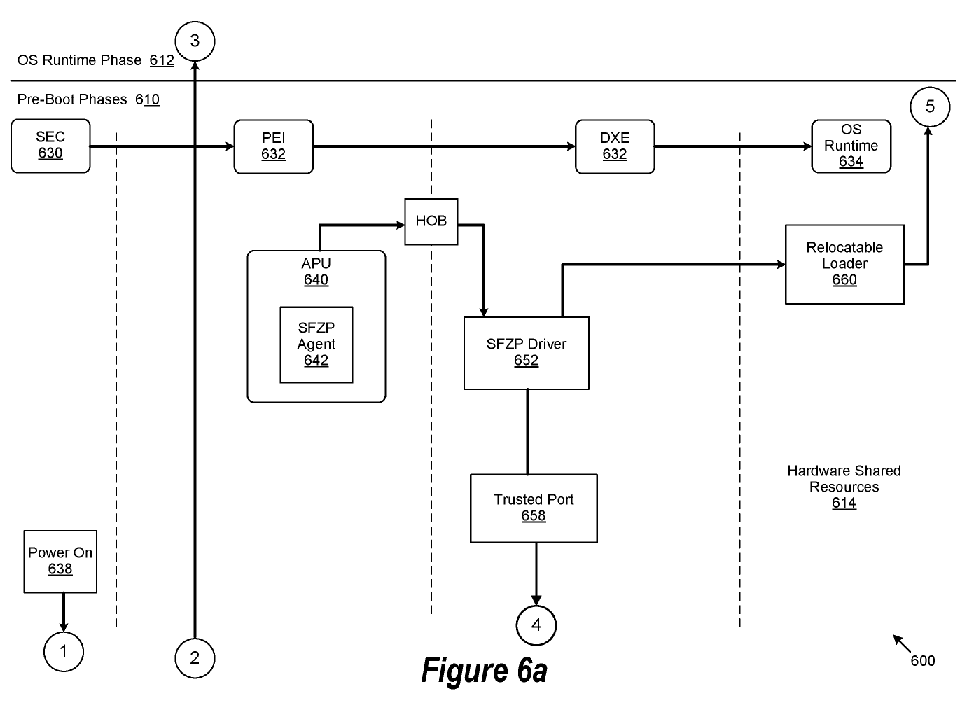

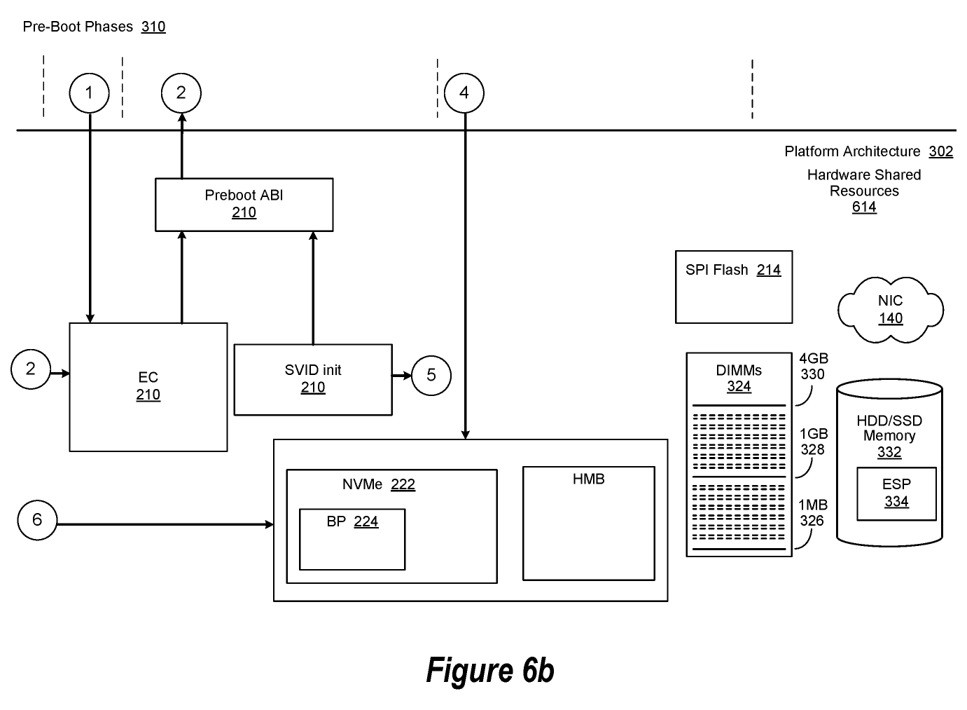

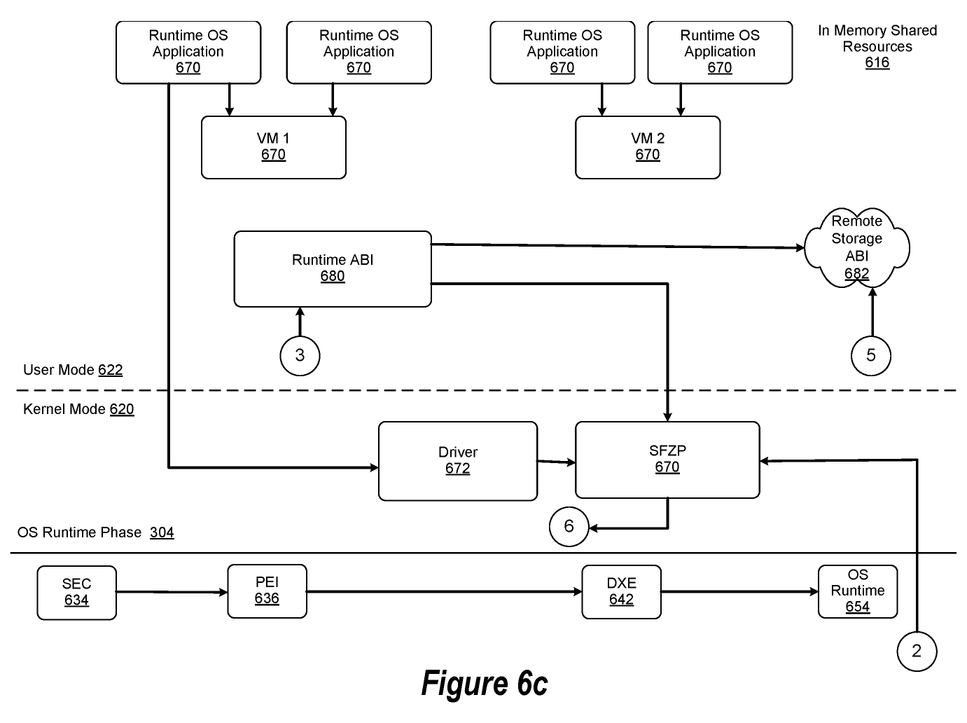

FIGS. 6a, 6b and 6c, generally referred to as FIG. 6, show a simplified block diagram showing a shared resource system 600. In certain embodiments, the shared resource system 600 is included within a trusted channel environment. In certain embodiments, the shared resource system 600 is included within an information handling system such as information handling system 100. In certain embodiments, the shared resource system 600 is included within a multi-processor operating environment such as multi-processor operating environment 200.

In certain embodiments, the shared resource trust operation includes a trusted channel operation. As used herein, a trusted channel operation broadly refers to a firmware management operation, described in greater detail herein, performed, directly or indirectly, within a multi-processor operating environment 200 to store, retrieve, aggregate, disaggregate, add, delete, modify, revise, update, replace, or restore shared resource trust information associated with a trusted channel.

In certain embodiments, the trusted channel operation generates a trusted channel. In certain embodiments, the trusted channel dynamically establishes an SVID and remote storage authorized application which can then securely access the information handling system resources.

In certain embodiments, the shared resource system 600 includes a pre-boot portion 610, a run time portion 612, or a combination thereof. In certain embodiments, components of the pre-boot portion 610, components of the platform architecture 302, or a combination thereof, include hardware shared resources 614. In certain embodiments, components of the run-time portion 612 include in-memory shared resources.

In certain embodiments, the run-time portion 612 includes a kernel mode portion 620, a user mode portion 622, or a combination thereof. In certain embodiments, the pre-boot portion includes an SEC phase 630, a PEI phase 632, a DXE phase 634, and a run-time phase 636.

In certain embodiments, the SEC phase 630 includes a power on module 638. In certain embodiments, the PEI phase 632 includes an accelerated processing unit 640. In certain embodiments, the accelerated processing unit 640 includes a SFZP agent 642. In certain embodiments, the PEI phase 632 communicates with the DXE phase 634 via a hand off block module 650. In certain embodiments, the DXE phase 644 includes a preboot SFZP driver 652, a trusted port 658, or a combination thereof. In certain embodiments, the operating system runtime phase 636 includes the relocatable loader module 660.

In certain embodiments, the kernel mode portion 620 includes a runtime secured firmware zero trust protocol (SFZP) module 670, a driver 672, or a combination thereof. In certain embodiments, the user mode portion 622 includes a runtime ABI 680, a remote storage ABI 682, or a combination thereof. In certain embodiments, the user mode portion 622 includes one or more applications 690, one or more virtual machines 692, or a combination thereof. In certain embodiments, the preboot SFZP driver 652 and the SFZP module 670, the driver 672, the runtime ABI 680, the remote storage ABI 682, or a combination thereof are included within an SFZP module.

In certain embodiments, when trusted and non-trusted applications, also referred to as workloads, request access to hardware resources, the SFZP driver generates security information for these workloads. In certain embodiments, the security information includes hashes such as DRTM type hashes. In certain embodiments, the security information provides attestation evidence. In certain embodiments, the driver then establishes temporary public/private key pairs for each workload to provide identity proof. The hardware resource initiates communication with the ABI interface. In certain embodiments, the hardware resource initiates communication with a preboot ABI, a runtime ABI, a remote storage ABI, or a combination thereof. In certain embodiments, the ABI interface is provided by a trusted third party. In certain embodiments, the trusted third party functions as an SPIFFE identity issuer. When performing the trusted channel operation, to provide attestation for the application the SFZP driver sends measurements in a certificate signing request (CSR) with the public key for endorsement. The third party verifies the measurements against reference values (e.g., stored within a reference integrity management (RIM) component as a mapping table of workloads against shared hardware). In certain embodiments, the third party also reviews an exception list. After verifying the signature of the attestation evidence and public key in the CSR, the SFZP driver generates a SVID for the resource. In certain embodiments, a SPIFFE runtime environment (SPIRE) assigns SVIDs to the workloads. The SVID is then returned to the shared resource. As used herein, SPIRE broadly relates to a production ready implementation of SPIFFE application program interfaces that provide node and workload attestation to securely issue SVIDs to workloads.

The workload seeking access to the shared resource uses the SVID of the workload to establish a mutual transport layer security (mTLS) session with the remote storage location before requesting access to the hardware. As used herein, a mutual transport layer security session broadly refers to a cryptographic session designed to provide secure communication between a client and a server over a network. Successful authentication results in a secure session for further transactions between the workload and the shared hardware. If the mTLS authentication fails, the SFZP driver deems the request invalid, and according to policy, takes necessary action to terminate the request.

Accordingly, the operating system runtime-mapped SFZP driver facilitates decision-making for accessing shared resources by verifying operating system policies upon successful authorization. The SFZP driver then uses the 3-factor authentication mechanism to provide a standardized, robust, secure communication at the operating system runtime to prevent unauthorized access and potential security threats.

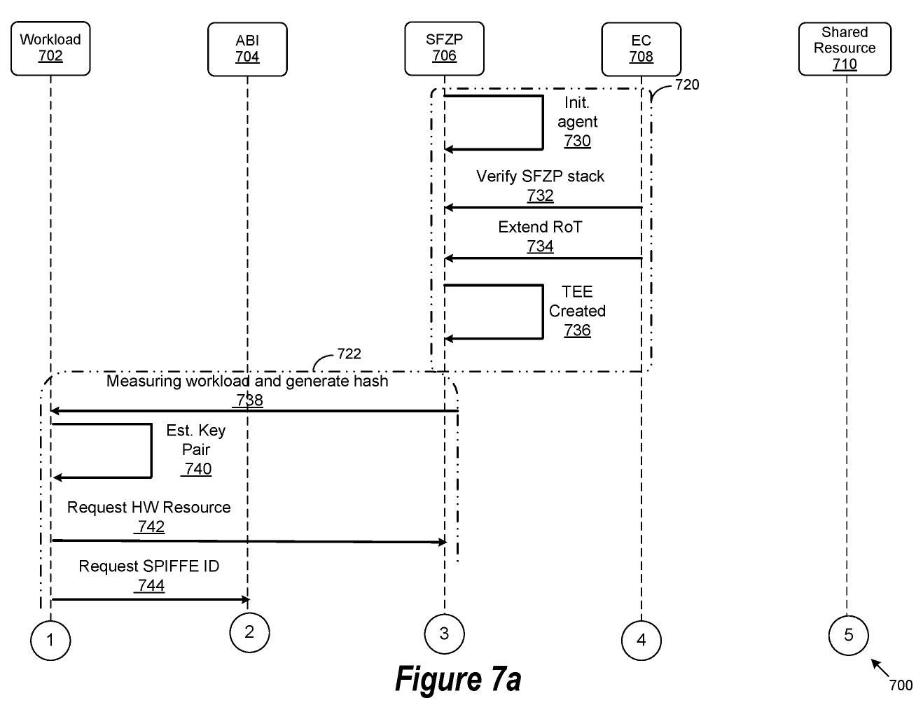

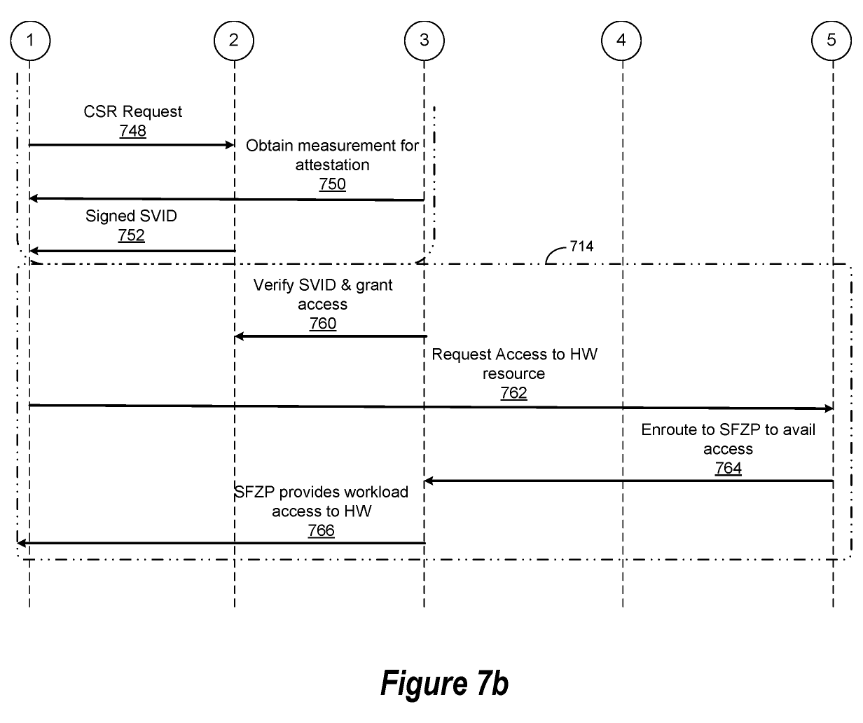

FIGS. 7a and 7b, generally referred to as FIG. 7, show a sequence diagram for a shared resource trust operation 700. More specifically, the shared resource operation 700 includes a plurality of steps occurring between a workload 702, an authenticated BIOS interface (ABI) 704, a secured firmware zero trust protocol (SFZP) module 706, an embedded controller (EC) 708 , a shared resource 710, or a combination thereof. In certain embodiments, the workload 702 corresponds to some or all of an application such as application 574. In certain embodiments, the ABI 704 corresponds to some or all of the ABI module 540. In certain embodiments, the embedded controller 708 corresponds to embedded controller 210. In certain embodiments, the shared resource corresponds to a hardware shared resource 514, an in memory shared resource 516, or a combination thereof.

In certain embodiments, the shared resource trust operation 700 includes an initialization portion 720, a confirmation portion 722 and an allocation portion 724. When performing the shared resource trust operation 700, the initialization portion begins operation by the SFZP module 706 initializing a SFZP agent during a pre boot phase of operation at step 730. Next at step 732, the shared resource trust operation 700 verifies the SFZP stack via the embedded controller 708. Next at step 734, the embedded controller 708 provides the SFZP module 706 with an extended root of trust. Next at step 736 a trusted execution environment (TEE) is created. The shared resource trust operation 700 then proceeds to the confirmation portion 722.

When performing the shared resource trust operation 700, the confirmation portion 722 begins operation at step 738 by measuring the workload and generating a hash for the workload. Next at step 740 a key pair is established for the workload 702. Next, the workload 702 requests access to a shared resource such as a shared hardware resource from the SFZP module 706 at step 742. Next, the workload 702 requests a SPIFFE identifier from the ABI 704 at step 744 and generates a CSR request from the ABI 704 at step 746. Next at step 748 the SFZP module 706 provides the workload 702 a measurement for attestation. Next at step 750, the ABI provides a signed SVID. The workload 702 then uses the signed SVID to request the SFZP module 706 provide access to the shared resource at step 752. The confirmation portion 722 then proceeds to the allocation portion 724.

When performing the shared resource trust operation 700, the confirmation portion 724 begins operation at step 760 by SFZP module 706 verifying the SVID for the workload 702 and granting access to the shared resource 710. The workload 702 then uses this information provided by the SFZP module 706 to communicate with the shared resource 710 and the request access to the shared resource. The shared resource 710 then, at step 764, provides information to the SFZP module 706 instructing the SFZP module to enroute the workload 702 to allow the workload access to the shared resource 710. Next, at step 766, the SFZP module 706 provides the workload 702 access to the shared resource 710.

As will be appreciated by one skilled in the art, the present invention may be embodied as a method, system, or computer program product. Accordingly, embodiments of the invention may be implemented entirely in hardware, entirely in software (including firmware, resident software, micro-code, etc.) or in an embodiment combining software and hardware. These various embodiments may all generally be referred to herein as a “circuit,” “module,” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example, but not limited to, an electronic, magnetic, optical, electromagnetic, infrared, or semiconductor system, apparatus, or device. More specific examples (a non-exhaustive list) of the computer-readable medium would include the following: a portable computer diskette, a hard disk, a random access memory (RAM), a read-only memory (ROM), an erasable programmable read-only memory (EPROM or flash memory), a portable compact disc read-only memory (CD-ROM), an optical storage device, or a magnetic storage device. In the context of this document, a computer-usable or computer-readable medium may be any medium that can contain, store, communicate, or transport the program for use by or in connection with the instruction execution system, apparatus, or device.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through a local area network (LAN) or a wide area network (WAN), or the connection may be made to an external computer (for example, through the Internet using an Internet Service Provider).

Embodiments of the invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

Consequently, the invention is intended to be limited only by the spirit and scope of the appended claims, giving full cognizance to equivalents in all respects.

What is claimed is:

1. A computer-implementable method for performing a firmware management operation, comprising:
providing an information handling system with a distributed Basic Input Output System (BIOS) and a shared resource;
identifying a processor environment installed on an information handling system from a plurality of processor environments, the processor environment comprising a processor architecture, the processor architecture comprising a plurality of processor core types; and,
performing a shared resource trust operation via the distributed BIOS, the shared resource trust operation using shared resource trust information to provide security measures which enable zero trust access by an application to the shared resource of the information handling system.

2. The method of claim 1, wherein:
the shared resource trust operation includes a trusted enclave operation, the trusted enclave operation using shared resource trust information to provide the information handling system with a trusted enclave.

3. The method of claim 2, wherein:
the trusted enclave operation interacts with a secured firmware trust protocol agent; and,
the secured firmware trust protocol agent includes a Secure Production Identity Framework for Everyone (SPIFFE) agent.

4. The method of claim 1, wherein:
the shared resource trust operation includes a secure signature trust operation, the secure signature trust operation using shared resource trust information to provide shared trust identification information.

5. The method of claim 4, wherein:
the shared trust identification information includes a Secure Production Identity Framework for Everyone (SPIFFE) Verifiable Identity Document (SVID) mapped secure signature; and
the secure signature trust operation uses a remote storage authenticated BIOS interface (ABI) based operating system runtime application to authorize a SVID mapped secure signature.

6. The method of claim 1, wherein:
the shared resource trust operation uses a secured firmware trust protocol, the secured firmware trust protocol providing a zero-trust framework for ensuring protection of the shared resource of the information handling system.

7. A system comprising:
a processor;
a data bus coupled to the processor; and
a non-transitory, computer-readable storage medium embodying computer program code, the non-transitory, computer-readable storage medium being coupled to the data bus, the computer program code interacting with a plurality of computer operations and comprising instructions executable by the processor and configured for:
providing an information handling system with a distributed Basic Input Output System (BIOS) and a shared resource;
identifying a processor environment installed on an information handling system from a plurality of processor environments, the processor environment comprising a processor architecture, the processor architecture comprising a plurality of processor core types; and,
performing a shared resource trust operation via the distributed BIOS, the shared resource trust operation using shared resource trust information to provide security measures which enable zero trust access by an application to the shared resource of the information handling system.

8. The system of claim 7, wherein:
the shared resource trust operation includes a trusted enclave operation, the trusted enclave operation using shared resource trust information to provide the information handling system with a trusted enclave.

9. The system of claim 8, wherein:
the trusted enclave operation interacts with a secured firmware trust protocol agent; and,
the secured firmware trust protocol agent includes a Secure Production Identity Framework for Everyone (SPIFFE) agent.

10. The system of claim 7, wherein:
the shared resource trust operation includes a secure signature trust operation, the secure signature trust operation using shared resource trust information to provide shared trust identification information.

11. The system of claim 10, wherein:
the shared trust identification information includes a Secure Production Identity Framework for Everyone (SPIFFE) Verifiable Identity Document (SVID) mapped secure signature; and
the secure signature trust operation uses a remote storage authenticated BIOS interface (ABI) based operating system runtime application to authorize a SVID mapped secure signature.

12. The system of claim 7, wherein:
the shared resource trust operation uses a secured firmware trust protocol, the secured firmware trust protocol providing a zero-trust framework for ensuring protection of the shared resource of the information handling system.

13. A non-transitory, computer-readable storage medium embodying computer program code, the computer program code comprising computer executable instructions configured for:
providing an information handling system with a distributed Basic Input Output System (BIOS) and a shared resource;
identifying a processor environment installed on an information handling system from a plurality of processor environments, the processor environment comprising a processor architecture, the processor architecture comprising a plurality of processor core types; and,
performing a shared resource trust operation via the distributed BIOS, the shared resource trust operation using shared resource trust information to provide security measures which enable zero trust access by an application to the shared resource of the information handling system.

14. The non-transitory, computer-readable storage medium of claim 13, wherein:
the shared resource trust operation includes a trusted enclave operation, the trusted enclave operation using shared resource trust information to provide the information handling system with a trusted enclave.

15. The non-transitory, computer-readable storage medium of claim 14, wherein:
the trusted enclave operation interacts with a secured firmware trust protocol agent; and,
the secured firmware trust protocol agent includes a Secure Production Identity Framework for Everyone (SPIFFE) agent.

16. The non-transitory, computer-readable storage medium of claim 13, wherein:
the shared resource trust operation includes a secure signature trust operation, the secure signature trust operation using shared resource trust information to provide shared trust identification information.

17. The non-transitory, computer-readable storage medium of claim 16, wherein:
the shared trust identification information includes a Secure Production Identity Framework for Everyone (SPIFFE) Verifiable Identity Document (SVID) mapped secure signature; and
the secure signature trust operation uses a remote storage authenticated BIOS interface (ABI) based operating system runtime application to authorize a SVID mapped secure signature.

18. The non-transitory, computer-readable storage medium of claim 13, wherein:
the shared resource trust operation uses a secured firmware trust protocol, the secured firmware trust protocol providing a zero-trust framework for ensuring protection of the shared resource of the information handling system.

19. The non-transitory, computer-readable storage medium of claim 13, wherein:
the computer executable instructions are deployable to a client system from a server system at a remote location.

20. The non-transitory, computer-readable storage medium of claim 13, wherein:
the computer executable instructions are provided by a service provider to a user on an on-demand basis.
